(19) United States
(12) Patent Application Publication
(10) Pub. No.: US 2005/0179269 A1
(43) Pub. Date: Aug. 18, 2005

(54) Gated rear entry for wheelchair

(75) Inventor: Michael James Weiland, Phoenix, AZ (US)

Correspondence Address: Paul F. Wille, 6407 E. Clinton St., Scottsdale, AZ, 85254, US

(73) Assignee: Vantage Mobility International, LLC, Phoenix, AZ (US)

(21) Appl. No.: 10/779,447

(22) Filed: Feb. 12, 2004

(51) Int. Cl. B60R 19/04

(52) U.S. Cl. 293/149; 296/25

(57) ABSTRACT

A mini-van includes a rear bumper that is divided into three sections. The central section is coupled one of the remaining sections by a four bar hinge that enables the central section to swing like a gate to provide access through the bumper to the rear opening of the minivan. The central section also includes a cover section for enclosing said drop floor and a latch that secures the rear door in a closed position. The four bar hinge allows the central section to move rearwardly from a closed position and then to rotate about said hinge.

### BACKGROUND OF THE INVENTION

This invention relates to a ramp for a minivan and, in particular, to a gated, rear, entry for a minivan.

The minivan of twenty years ago has evolved over several generations into a variety of vehicles, each based on an automotive or light duty chassis, characterized by a boxy appearance and a rear door or lift gate. As used herein, the term “minivan” is intended to cover all such vehicles because any such vehicle can benefit from the invention.

A variety of small motorized scooters have been developed to carry a seated person through areas intended for pedestrian traffic. These scooters are battery powered, ride on either three or four small wheels, and are relatively compact but can be rather heavy because of the battery and electric motor. Unlike powered or unpowered wheelchairs, motorized scooters are usually not driven into a van or other vehicle with a person seated on the scooter. Rather, a lift is provided for attaching a scooter to the van for traveling long distances.

Powered wheelchairs and scooters are evolving toward each other, making terminology imprecise. One manufacturer avoids the problem and calls its product a “highly maneuverable vehicle.” Some vehicles have wheels at the corners of a rectangle with the driven axle parallel to one side of the rectangle. Other vehicles have wheels at the corners of a diamond, with the driven axle parallel to a diagonal of the diamond. As used herein, “wheelchair” is intended to be generic to all such vehicles, including unpowered wheelchairs, for aiding a person of limited mobility.

It is known in the art to provide a mechanism for enabling a person in a wheelchair to enter or leave a vehicle. Trucks, buses, and large vans have high ground clearance and are typically provided with a lift rather than a ramp, which would be too long or too steep because of the high ground clearance. Any ramp associated with a lift for a vehicle having a high ground clearance merely provides a gradual transition from the ground to the height of a platform that is raised or lowered. A minivan has a lower ground clearance than larger vehicles. Thus, a ramp can be used without a lift and the ramp either folds when stored or slides into the minivan.

It is known in the art to provide a rear entry in a minivan for a wheelchair; see U.S. Pat. No. 5,137,413 (Ressler). As described in the patent, a central section of the rear bumper is removed and attached to the outside of a folding ramp. This necessarily restricts the type of ramp to a folding ramp.

The ramp for a rear entrance is flat, or with very low walls for guiding a wheelchair, to avoid having the walls protrude into the minivan when the ramp is stowed. With a substantially flat ramp, a person in a wheelchair must negotiate a narrow path that may or may not be level from side to side. For example, if the minivan is parked along the side of a crown road, the minivan and the ramp are tipped to one side. This can make entering or leaving the minivan something of an adventure, which is not always welcome.

In view of the foregoing, it is therefore an object of the invention to provide a gated rear entry for a minivan.

Another object of the invention is to provide a gated rear entry for a minivan wherein the gate also serves as a railing.

A further object of the invention is to provide a rear entry for a minivan that is compatible with folding ramps and slide-out ramps.

Another object of the invention is to provide a gated rear entry that is aesthetically pleasing in a minivan.

### SUMMARY OF THE INVENTION

The foregoing objects are achieved in this invention in which a mini-van includes a rear bumper that is divided into three sections. The central section is coupled to one of the remaining sections by a four bar hinge that enables the central section to swing like a gate to provide access through the bumper to the rear opening of the minivan. The central section also includes a cover section for enclosing said drop floor and a latch that secures the rear door in a closed position. The four bar hinge allows the central section to move rearwardly from a closed position and then to rotate about said hinge.

### BRIEF DESCRIPTION OF THE DRAWINGS

A more complete understanding of the invention can be obtained by considering the following detailed description in conjunction with the accompanying drawings, in which:

FIG. 1 is a perspective view of a minivan modified for rear entry by a wheelchair;

FIG. 2 is a perspective view of a gate constructed in accordance with the invention and in a closed position;

FIG. 3 is a perspective view of a gate constructed in accordance with the invention and in an open position;

FIG. 4 is a perspective view of a portion of a four bar hinge used for mounting the gate; and

FIG. 5 is a perspective view of a second portion of a four bar hinge used for mounting the gate.

### DETAILED DESCRIPTION OF THE INVENTION

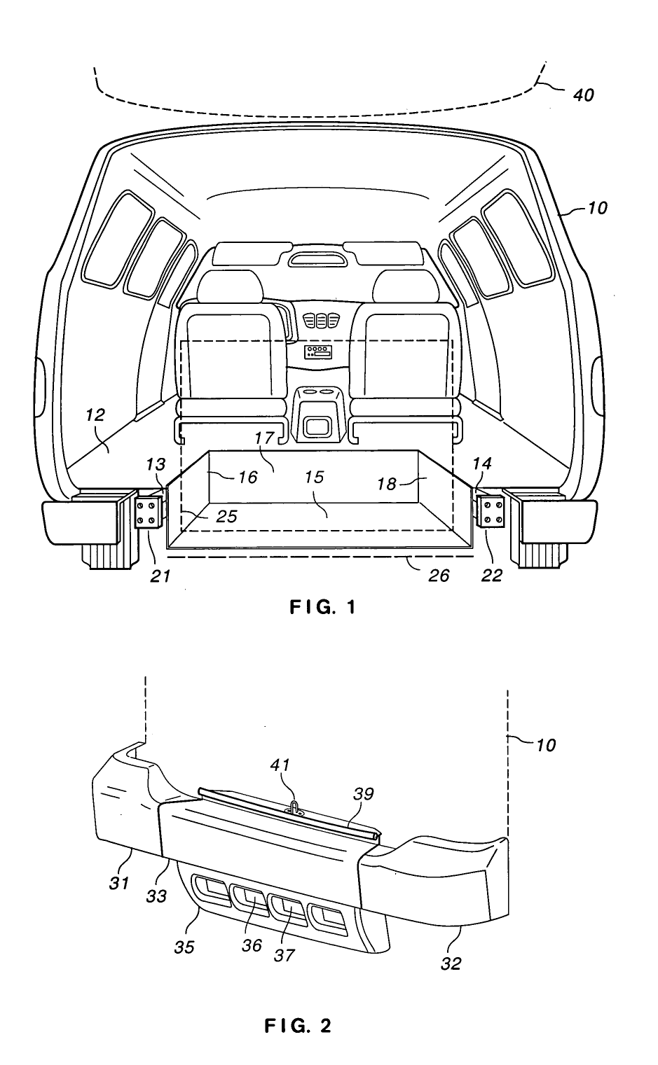

FIG. 1 is a perspective view of the rear of a minivan that has been modified for rear entry. Specifically, floor 12 has had a portion removed between frame rails 13 and 14 to make room for a lowered floor pan including floor 15, left sidewall 16, rear sidewall 17, and right sidewall 18. The open-ended box defined by floor pan 15 and sidewalls 16-18 is welded or suitably attached to the remainder of the floor pan and then finished to match the original flooring.

Plate 21 is securely attached to frame rail 13 and plate 22 is securely attached to frame rail 14, by bolts or by welding. Either a fold-out ramp, represented by dashed line 25, or a slide-out ramp, represented by dashed line 26, can be used in a minivan modified in accordance with the invention. The bumper, and its decorative “skin” is segmented to provide structure for the gate. In particular, the bumper is divided into three sections, with the middle section having a width substantially corresponding to the width between sidewalls 16 and 18.

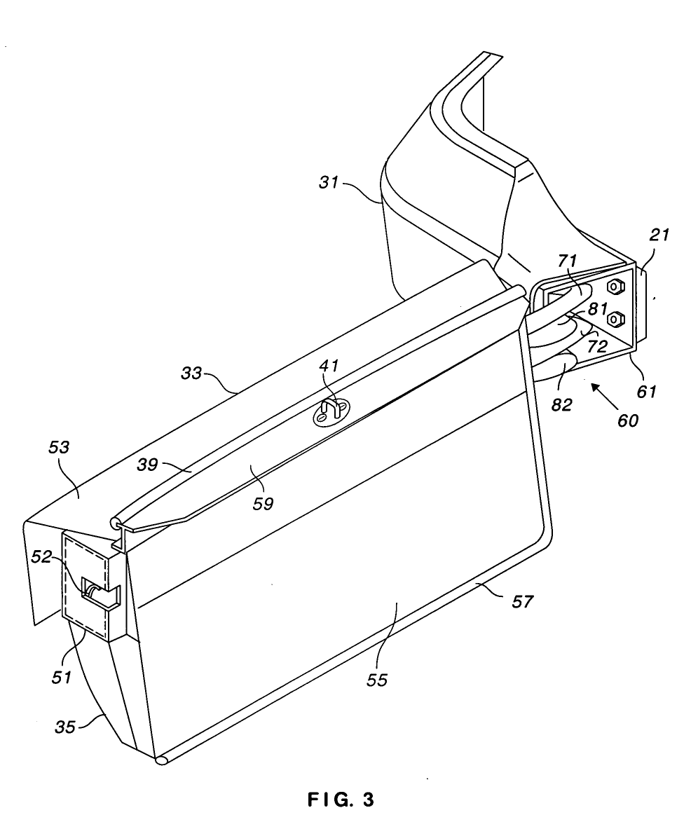

FIG. 2 illustrates a gate constructed in accordance with a preferred embodiment of the invention. Section 31 and section 32 remain attached to minivan 10, represented by dashed lines in FIG. 2. Gate 33 includes a steel tube (not shown in FIG. 2) to which the middle section of the bumper is attached. A plastic covering typically overlies the steel portion of a bumper and this covering or “skin” is also retained.

Cover section 35 is added below the bumper for sealing the open-ended box formed in the floor. Cover 35 preferably includes some decorative detail, such as indentations 36 and 37 to provide a more pleasant appearance. Weather strip 39 is provided for engaging lift gate 40 (FIG. 1) when the lift gate is closed. Latch 41 is attached to the steel tube and engages a suitable clasp in lift gate 40. Thus, except for the addition of cover 35, minivan 10 looks and functions in the same manner as an unmodified minivan.

Gate 33 rotates about a substantially vertical axis and can be hinged on either side. As illustrated in FIG. 3, gate 33 is hinged on the left. Tube 51 is made from steel, preferably rectangular in cross-section, and extends from left to right across the interior of gate 33. As illustrated in FIG. 3, latch 52 is attached to the left hand end of tube 51 and engages a suitable bolt or catch (not shown) on section 32 (FIG. 2). The latch can be operated as the other doors of the minivan; directly, by a mechanical connection to a handle (not shown), or indirectly, by a remotely controlled electronic release (not shown).

Bumper section 53 is attached to the outside of tube 51 and cover 35 is attached to the lower portion of the tube. The interior side of gate 33 is provided with cover panel 55 that matches the interior of the minivan. Weather strip 57 engages the ends of the sidewalls and floor shown in FIG. 1 to seal out weather and noise. Latch 41 is attached to steel section 59, which is attached to tube 51, e.g. preferably by welding. Weather strip 39 is removably mounted on section 59. In addition to providing support for latch 41 and weather strip 39, plate 59 also serves as a protective railing when the gate is opened. Appropriately molded handles or grabs could also be added.

Section 31 of the rear bumper includes steel tube 61, attached to plate 21 by four bolts. Tube 51 is coupled to tube 61 by four bar hinge 60. A four bar hinge is typically used in automobiles for trunk lids, see U.S. Pat. No. 6,250,707 (Dintner et al.), convertible tops, or for hoods or bonnets.

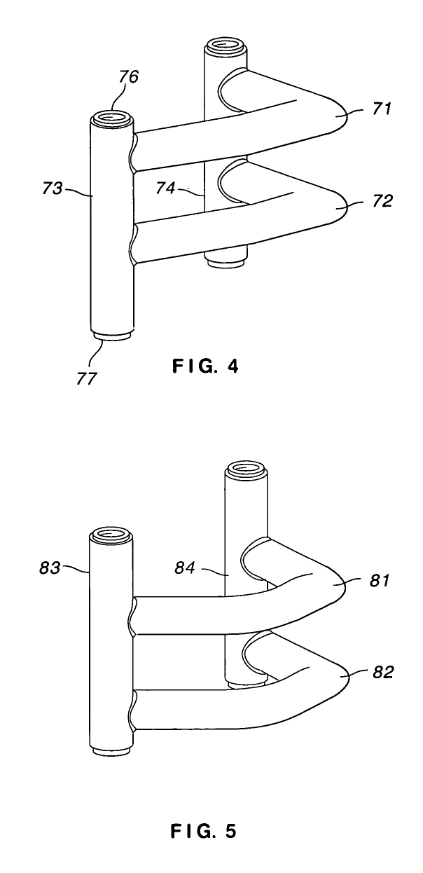

FIG. 4 illustrates a first pair of bars from the four bar hinge used in the invention. FIG. 5 illustrates a second pair of bars from the four bar hinge used in the invention. In FIG. 4, bar 71 and bar 72 are welded to posts 73 and 74, maintaining the posts in a parallel orientation. Each post is a tube and includes a bearing at each end, such as bearings 76 and 77. In FIG. 5, bar 81 and bar 82 are welded to posts 83 and 84, maintaining the posts in parallel alignment. Posts 73 and 74 also have a bearing at each end.

When attached to tubes 51 and 61 (FIG. 3), bar 71 is above bar 81, which is above bar 72, which is above bar 82. Posts 74 and 84 are attached to tube 61 by bolts through the posts and through holes in the tubes. Posts 73 and 83 are attached to tube 51 (FIG. 3) by bolts extending through the posts and the tubes. The bolts are arranged such that the bolt heads are at the corners of a trapezoid. Thus connected, there are two rotations that can take place. The bars can rotate about the bolts through tubes 74 and 84 and gate 33 can rotate about the bolts in posts 73 and 83. The net motion with the four posts is that the gate moves horizontally away from the back of the minivan before swinging open. Stated another way, the gate translates, then pivots.

There are several advantages to this construction. First, the four bar hinge constructed as shown is very strong. Second, the horizontal motion means that there is no rubbing of the gate on the weather stripping, causing wear as the gate is opened and closed. The gate moves into and out of engagement. Third, the gate can be made with very narrow gaps in the bumper, making the gate less conspicuous than it would be with other types of hinges. The gate initially moves parallel with the sides of the gate. If the gate pivoted on a simple hinge, the thickness of the gate would require large gaps between sections of the bumper for clearance. There would also be considerable rubbing of the weather stripping at the hinge side of the gate.

The invention thus provides a gated rear entry for a minivan, wherein the gate also serves as a railing and as a warning barrier to notify others that the ramp is in use. The gate is compatible with folding ramps and slide-out ramps because the gate is not attached to the ramp. A gate constructed in accordance with the invention is aesthetically pleasing and inconspicuous.

Having thus described the invention, it will be apparent to those of skill in the art that various modifications can be made within the scope of the invention. For example, the gate can be operated electronically or manually and can include a powered assist for opening the gate and holding the gate open; e.g. a pneumatic tube, electric motor, or hydraulic actuator. Coordinating the motion of the ramp, the lift gate, and the bumper gate is suitable electronics (not shown). Although shown and described in connection with a lift gate, the rear door of the minivan can be a single door hinged on one side of the minivan or double doors (“barn doors”). Although shown and described in connection with a minivan having a drop floor, a bumper gate constructed in accordance with the invention can be used on a minivan without a drop floor. The invention cannot be used in a minivan having a tailgate; that is, a gate hinged at the bottom. Instead of a bearing at each end of the posts for the hinge, one could have a single bearing extend through the length of the post. While disclosed in connection with a bumper divided into three sections, the invention could be implemented using a bumper divided into four sections with the two center sections opening to each side.

1. In a mini-van having a rear opening, a rear door closing the rear opening, and an extendible ramp for providing access to the rear of the minivan, the improvement comprising
a bumper divided into at least three sections, wherein a central section is coupled to one of the remaining sections by a hinge that enables the central section to swing like a gate to provide access through the bumper to the rear opening.

2. The minivan as set forth in claim 1 wherein said minivan includes a drop floor extending to said rear opening and said central section includes a cover section attached to the lower portion of said central section for enclosing said drop floor.

3. The minivan as set forth in claim 1 wherein said central section is wider than said ramp.

4. The minivan as set forth in claim 1 wherein said central section includes a latch that secures the rear door in a closed position.

5. The minivan as set forth in claim 1 wherein said central section is coupled to one of the remaining sections by a four bar hinge.

6. The minivan as set forth in claim 5 wherein said four bar hinge causes said central section to move rearwardly from a closed position and then to rotate about said hinge.

7. In a mini-van having a rear opening, a rear door closing the rear opening, and an extendible ramp for providing access to the rear of the minivan, the improvement comprising:
a gate adjacent the rear opening, said gate pivoting about a substantially vertical axis to provide access to the rear opening.

8. The minivan as set forth in claim 7 wherein said gate is coupled to said minivan by a four bar hinge.

9. The minivan as set forth in claim 8 wherein said four bar hinge causes said gate to translate and then rotate as the gate is opened and to rotate and then translate as the gate is closed.

10. The minivan as set forth in claim 7 wherein said gate includes a latch that attaches the rear door to the gate.
